(19) United States
(12) Patent Application Publication
(10) Pub. No.: US 2016/0051988 A1
(43) Pub. Date: Feb. 25, 2016

(54) TOP SERVICE CLAMPING CYLINDERS FOR A GYRATORY CRUSHER

(71) Applicant: Metso Minerals Industries, Inc., Waukesha, WI (US)

(72) Inventor: Dean Michael Kaja, Milwaukee, WI (US)

(73) Assignee: METSO MINERALS INDUSTRIES, INC., Waukesha, WI (US)

(21) Appl. No.: 14/463,185

(22) Filed: Aug. 19, 2014

(51) Int. Cl. B02C 2/04

(52) U.S. Cl. CPC B02C 2/045

(57) ABSTRACT

A system and method for providing the required clamping force between an adjustment ring and bowl of a gyratory crusher is disclosed. The clamp ring includes a series of clamping cylinder assemblies that each are mounted to a top face of the clamp ring. Each of the clamping cylinder assemblies can be removed and replaced from the top surface of the clamp ring without requiring the removal of the clamp ring from the gyratory crusher. Each clamping cylinder assembly includes a mounting flange that is attached to the clamp ring through a series of connectors.

### BACKGROUND OF THE INVENTION

The present disclosure generally relates to gyratory rock crushing equipment. More specifically, the present disclosure relates to the system and method for integrating clamping cylinders into a cone crusher where the clamping cylinders can be serviced from the top of the cone crusher.

Rock crushing systems, such as those referred to as cone crushers, generally break apart rock, stones or other material in a crushing gap between a stationary element and a moving element. For example, a cone crusher is comprised of a head assembly including a crushing head that gyrates about a vertical axis within a stationary bowl positioned within the mainframe of the rock crusher. The crushing head is assembled surrounding an eccentric that rotates about a fixed main shaft to impart the gyrational movement to the crushing head, which crushes rock, stone or other materials in a crushing gap between the crushing head and the bowl. The eccentric can be driven by a variety of power drives, such as an attached gear, driven by a pinion and countershaft assembly, and a number of mechanical power sources, such as electrical motors or combustion engines can be used.

The crushing head of large cone crushers is rotatably supported about a stationary main shaft. The cone crusher includes a bowl that supports a bowl liner to define the crushing gap between the bowl liner and the crushing head. The bowl contained within the cone crusher is vertically adjustable relative to the head assembly to vary the size of the crushing gap. In some applications, the cone crusher includes a stationary adjustment ring that includes a series of threads along which the bowl can move to adjust the crushing gap. The bowl is rotatable within the adjustment ring and the direction of rotation controls the vertical movement of the bowl to either increase or decrease the crushing gap. Some of these cone crushers also include a clamp ring that is used to create a clamping force to lock the bowl into position relative to the stationary adjustment ring.

In currently available cone crushers, when the clamping cylinders need to be removed or serviced, the entire clamp ring must be removed from the cone crusher before the clamping cylinders can be accessed. Removing the clamp ring from the cone crusher requires the removal of both the feed arrangement and the bowl to provide access to the clamp ring, which must then be removed. Servicing the clamping cylinders using such a replacement process take a relatively large amount of time, during which the cone crusher is out of operation and not generating income.

### SUMMARY OF THE INVENTION

The present disclosure relates to a system and method for integrating clamping cylinders into a cone crusher such that the clamping cylinders can be serviced from the top of the cone crusher to facilitate the ease of maintenance and servicing. Each of the clamping cylinders can be accessed and serviced without having to remove the feed arrangement, bowl and clamp ring from the gyratory crusher.

The gyratory crusher of the present disclosure includes an adjustment ring that is stationary during normal crushing operation. The adjustment ring includes a series of threads. A bowl, which includes a bowl liner that defines a portion of the crushing gap of the cone crusher, is positioned within the stationary adjustment ring. The bowl includes a series of external threads that engage the threads formed on the adjustment ring. Rotation of the bowl relative to the stationary adjustment ring causes the bowl to move vertically relative to the stationary adjustment ring. Through rotation of the bowl in either direction, the size of the crushing gap can be adjusted.

The gyratory crusher further includes a head assembly that is positioned for movement within the bowl. The head assembly consists of a head and a mantle liner placed on the head which define a portion of the crushing gap between the head assembly and the bowl.

The gyratory crusher further includes a clamp ring that is positioned above the adjustment ring. The clamp ring includes a series of threads that engage the external threads of the bowl. The clamp ring is an annular member that includes a top face and a bottom face and a series of bores spaced around the annular body of the clamp ring. Each of the bores formed in the clamp ring receives one of a plurality of clamping cylinder assemblies. Each of the clamping cylinder assemblies is mounted to the top face of the clamp ring and can be actuated to create a clamping force the locks the bowl to the adjustment ring. The clamping force created by the plurality of clamping cylinder assemblies resists the relative rotation between the adjustment ring and bowl during operation of the gyratory crusher.

Each of the clamping cylinder assemblies includes a cylinder body that is received within one of the bores that extends through the clamp ring from the top face to the bottom face. The cylinder body receives a movable piston that is received within an open interior defined by the cylinder body. When pressurized hydraulic fluid is supplied into the open interior of the cylinder body, the hydraulic fluid forces the piston toward the adjustment ring. The movement of the piston forces the entire clamp ring upward, which then results in upward movement of the bowl. The upward movement of the bowl causes the external threads on the bowl to engage the threads on the adjustment ring. This engagement resists the rotational movement of the bowl relative to the adjustment ring.

Each of the clamping cylinder assemblies is mounted to the top face of the clamp ring such that each of the clamping cylinder assemblies can be removed from the top face of the clamp ring without having to remove the clamp ring from the cone crusher. The clamping cylinder assemblies are each held in place on the top face by a plurality of connectors that can be removed from the clamp ring to allow replacement and servicing of the clamping cylinder assemblies.

Various other features, objects and advantages of the disclosure will be made apparent from the following description taken together with the drawings.

### BRIEF DESCRIPTION OF THE DRAWINGS

The drawings illustrate the best mode presently contemplated carrying out the disclosure. In the drawings:

FIG. 1 is an isometric view of a cone crusher with a partial section removed to show the clamping cylinders and the clamp ring of the present disclosure;

FIG. 2 is a magnified view taken along line 2-2 of FIG. 1;

FIG. 3 is a bottom isometric view showing the clamp ring and clamping cylinder assemblies;

FIG. 4 is a partial section view of the cone crusher;

FIG. 5 is a magnified view of the section shown by line 5-5 in FIG. 4;

FIG. 6 is a section view similar to FIG. 5 illustrating the upward movement of the clamp ring;

FIG. 7 is an exploded, section view of one of le clamping cylinder assemblies; and

FIG. 8 is a section view showing an alternate configuration for the clamp ring and one of the clamping cylinder assemblies.

### DETAILED DESCRIPTION

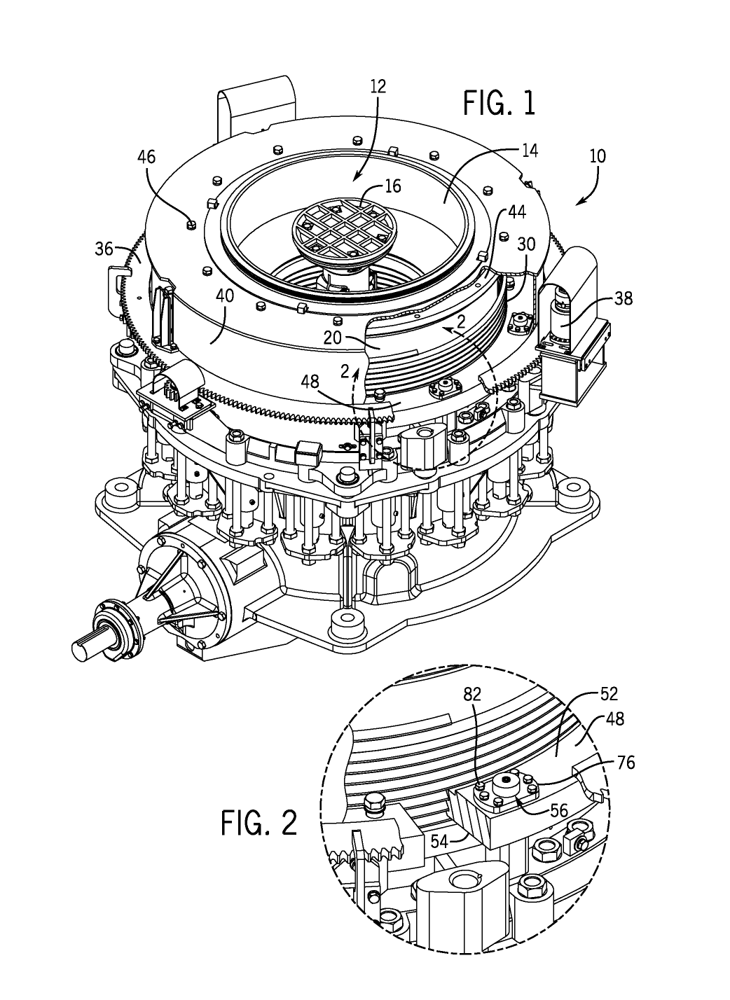

FIG. 1 illustrates a gyratory crusher, such as a cone crusher 10, that is operable to crush material, such as rock, stone, or mineral or other substances. The cone crusher 10 includes a central opening 12 that receives the material to be crushed. The central opening 12 is defined by a feed bowl hopper 14 which surrounds a cone feed plate 16.

As best shown in FIG. 4, the feed plate is 16 is mounted to the top of a head assembly 18 that is gyrationally movable within a bowl 20 that supports a bowl liner 22. The head assembly 18 includes a cone-shaped head 24 that includes a mantle 26. Both the mantle 26 and the bowl liner 22 are designed to be a replaceable wear component, since each of these two components define the primary contact surfaces within the crushing gap 28.

As can be understood in FIG. 4, the bowl 20 includes a series of external threads 30 that engage a corresponding series of threads 32 formed on a stationary adjustment ring 34. The interaction between the external threads 30 formed on the bowl 20 and the threads 32 formed on the adjustment ring 34 creates vertical movement of the bowl 20 relative to the stationary adjustment ring 34 upon rotation of the bowl 20. The direction of rotation of the bowl 20 dictates the direction of vertical movement of the bowl relative to the adjustment ring 34.

As can be understood in FIGS. 1 and 4, the bowl 20 is connected to an outer gear ring 36 which is driven by an adjustment motor 38. When the adjustment motor 38 operates, the gear ring 36 rotates, which in turn imparts rotation to the bowl 20 through the adjustment cap 40. The adjustment cap 40 is securely attached to a top flange 44 of the bowl 20 through a series of connectors 46. Rotation of the bowl 20 relative to the adjustment ring 34 causes the bowl 20 to move vertically relative to the adjustment ring 34.

Since the bowl 20 is designed to be movable relative to the stationary adjustment ring 34 to adjust the size of the crushing gap, the cone crusher 10 of the present disclosure includes a clamp ring 48 that is used to create a clawing force between the external threads 30 of the bowl 20 and the threads 32 of the adjustment ring 34. The clamping force created by the clamp ring 48 prevents rotational movement between the bowl 20 and the adjustment ring 34 during operation of the cone crusher.

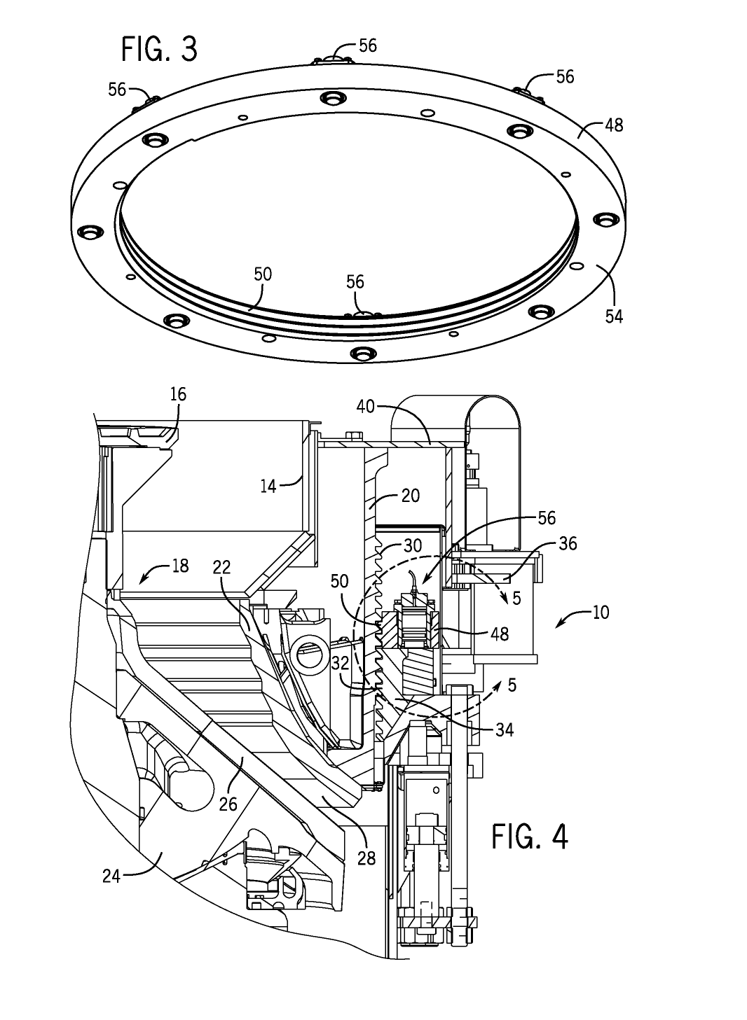

As illustrated in FIG. 4, the clamp ring 48 includes a series of threads 50 that engage the external threads 30 formed on the bowl 20. The clamp ring 48 is an annular member having a generally planar top face 52 and generally planar bottom face 54 as best illustrated in FIG. 2. The clamp ring 48 includes a plurality of clamping cylinder assemblies 56 that are spaced around the annular clamp ring 48. As shown in FIG. 3, the clamp ring 48 includes eight clamping cylinder assemblies 56 equally spaced around the annular clamp ring 48. Although eight clawing cylinder assemblies 56 are shown in the embodiment of the disclosure, it is contemplated that either a larger or fewer number of clamping cylinder assemblies 56 could be utilized while operating within the scope of the present disclosure.

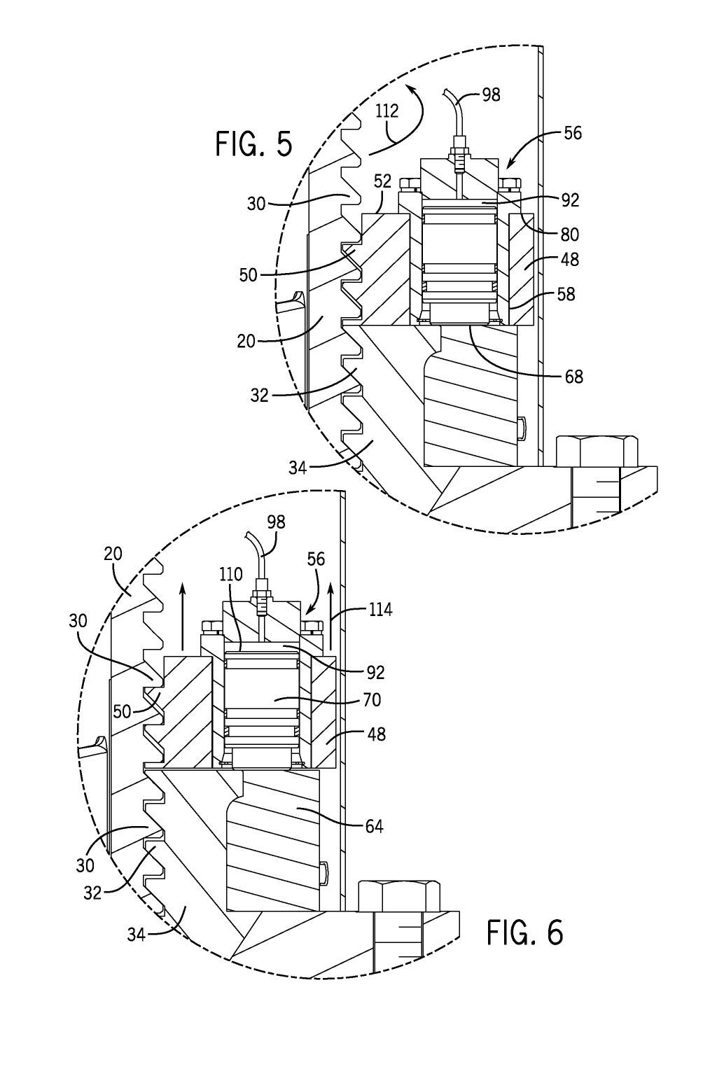

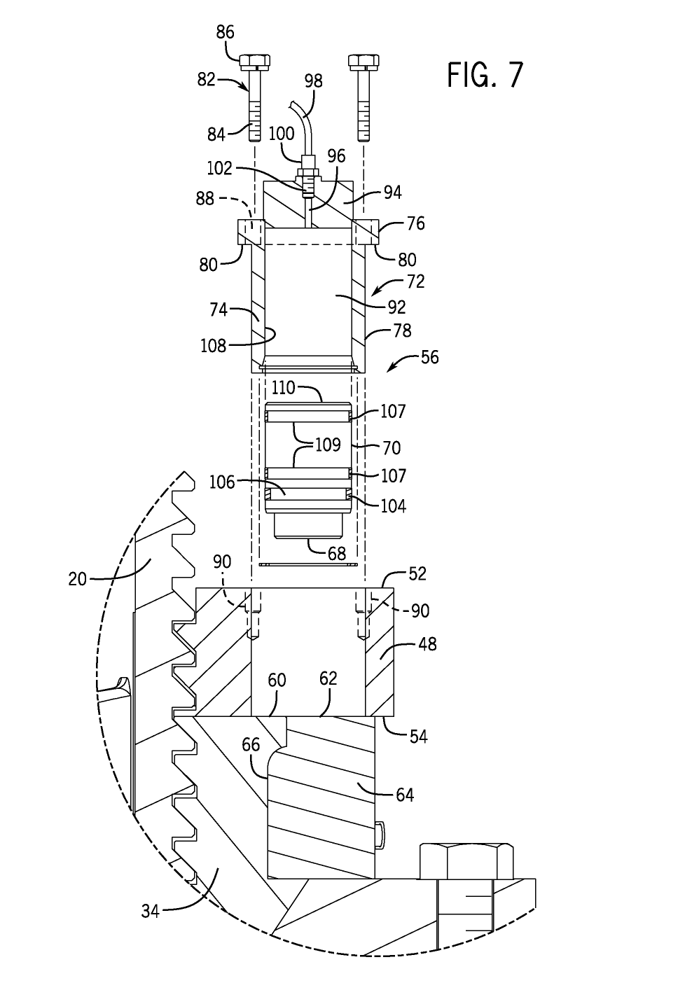

FIGS. 5 and 7 illustrate one of the plurality of clamping cylinder assemblies 56 positioned within one of the bores 58 formed in the clamp ring 48. As illustrated in FIGS. 5 and 7, the bottom face 54 of the clamp ring 48 contacts a top surface 60 of the adjustment ring 34 and a corresponding top surface 62 of a spacer 64 mounted to an outer surface 66 of the adjustment ring 34. Although a spacer 64 is shown in the drawings, the spacer 64 could be eliminated depending on the configuration of the cone crusher. The spacer 64 is securely attached to the adjustment ring by welding or bolts and provides a contact surface for the clamping cylinder assemblies 56. The top surfaces 60, 62 are generally coplanar with each other and provide a contact surface for engagement with the lower contact surface 68 of the movable piston 70 that forms part of the clamping cylinder assembly 56.

As shown in FIG. 7, the clamping cylinder assembly 56 includes a cylinder body 72 including a cylindrical outer wall 74 that is joined to and depends from a mounting flange 76. The mounting flange 76 extends past the outer surface 78 of the outer wall 74 to define a support shoulder 80 that surrounds the outer wall 74. When the clamping cylinder assembly 56 is installed as shown in FIG. 5, the support shoulder 80 contacts the top surface 52 of the clamp ring 48.

As illustrated in FIG. 2, the mounting flange 76 is securely attached to the top face 52 of the clamp ring 48 by a series of connectors, such as bolts 82. In the embodiment shown, six bolts 82 are used to attach the mounting flange 76 to the top face 52. Although six bolts 82 are shown, fewer or additional bolts 82 could be utilized depending upon the size of the cone crusher and design requirements.

As illustrated in FIG. 7, each of the bolts 82 includes a threaded shaft 84 and a head 86. The threaded shaft 84 extends through an opening 88 formed in the mounting flange 76 and is received within a bore 90 that extends into the clamp ring 48 from the top face 52. The bore 90 includes internal threads that engage the threaded shaft 84 of the bolt 82. In this manner, the cylinder body 72 is securely attached to the top face 52 of the clamp ring 48.

As illustrated in FIG. 7, the cylinder body 72 includes an open interior 92 that receives the piston 70. The top end of the open interior 92 is closed by a pressure head 94 that is welded to the mounting flange 76. The pressure head 94 includes a fluid passageway 96 that allows pressurized hydraulic fluid to travel into the open interior 92 from a fluid conduit 98. A pressure fitting 100 receives the fluid conduit 98 and includes a lower, threaded portion 102 that is received within an internally threaded bore formed in the pressure head 94.

As illustrated in FIGS. 5 and 7, the piston 70 includes a resilient sealing ring 104 positioned in the lowermost groove 106 formed in the body of the movable piston 70. The resilient sealing ring 104 engages the inner surface 108 of the outer walls 74 to provide a fluid tight seal. A pair of non-metallic wear rings 107 are positioned in a pair of upper grooves 109 to prevent metal-to-metal contact between the piston 70 and the inner surface 108. As pressurized hydraulic fluid from the fluid conduit 98 is introduced into the open interior 92 above the top, pressure face 110, the pressure created by the hydraulic fluid forces the piston 70 downward. The downward movement of the piston 70 causes the contact surface 68 to engage the top surfaces 60, 62 of the adjustment ring 34 and spacer 64, respectively.

Referring now to FIG. 5, when no hydraulic fluid is supplied to the clamping cylinder assembly 56, the threads 50 formed on the clamp ring 48 and the external threads 30 formed on the bowl 20 are loosely in contact with each other. Likewise, the threads 32 formed on the adjustment ring 34 and the external threads 30 are also loosely in contact with each other. In this condition, the bowl 20 can be freely rotated, as shown by arrow 112, to move the bowl 20 vertically relative to the stationary adjustment ring 34. When hydraulic fluid is not supplied to the clamping cylinder assemblies 56 through the individual fluid conduits 98, the bowl 20 can move relative to the adjustment ring 34.

Once the bowl 20 is in the desired position to define the desired crushing gap, pressurized hydraulic fluid is supplied to each of the clamping cylinder assemblies 56 through the respective fluid conduits 98. When pressurized hydraulic fluid is supplied to the open interior 92 above the top, contact surface 110 of the piston 70, the pressurized hydraulic fluid forces the piston 70 downward into contact with the top surfaces of both the spacer 64 and the adjustment ring 34. Since both the spacer 64 and the adjustment ring 34 are stationary, the downward movement of the piston 70 forces the entire clamp ring 48 upward as illustrated by arrows 114 in FIG. 6.

The upward movement of the clamp ring 48 causes the threads 50 of the clamping ring to engage the outer threads 30 of the bowl 20. The engagement between the threads 50 and the threads 30 causes the bowl 20 to move slightly upward, which causes the threads 30 of the bowl 20 to engage the threads 32 of the adjustment ring 34. The engagement between the threads 30 of the bowl 20 and the threads 32 of the adjustment ring 34 creates a ht, frictional fit that resists rotational movement of the bowl 20 relative to the adjustment ring 34. Thus, when the cone crusher is in operation, each of the clamping cylinder assemblies 56 is pressurized to create a friction tit between the bowl 20 and the adjustment ring 34, which resist the rotational movement between the bowl 20 and the adjustment ring 34.

During the extended use of the cone crusher, the sealing ring 104 shown in FIG. 7 eventually begins to fail, which causes the clamping cylinder assembly 56 to begin leaking hydraulic fluid. As more and more hydraulic fluid begins to leak out of the clamping cylinder assemblies. It becomes necessary to service the clamping cylinder assemblies 56. In order to access the individual clamping cylinder assemblies 56, it is first necessary to access the clamp ring by initially raising or removing the adjustment cap 40 which is mounted to the bowl 20. Once these components are removed. each of the clamping cylinder assemblies 56 is accessible from the top of the cone crusher 10. Since each of the clamping cylinder assemblies are mounted to the top face 52 of the clamp ring 48, the individual clamping cylinder assemblies 56 can be removed and replaced by simply removing the series of bolts 82 and lifting the entire clamping cylinder assembly 56 from within the respective bore contained in the clamp ring 48. Once the clamping cylinder assembly 56 has been serviced, the entire clamping cylinder assembly 56 can be replaced and secured to the clamp ring 48 by retightening the individual bolts 82.

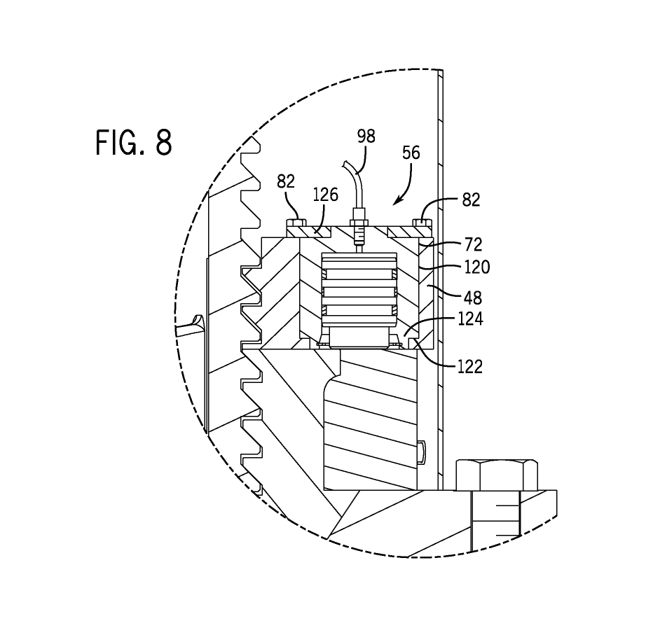

FIG. 8 illustrates an alternate arrangement for the clamping cylinder assembly 56. In the embodiment shown in FIG. 8, the clamp ring 48 includes an inner bore 120 having a slightly different configuration than shown in the embodiment of FIGS. 5-7. In the embodiment shown in FIG. 8, the bore 120 has a step that defines the lower shoulder 122. The lower shoulder 122 engages and supports a corresponding flange 124 formed on the cylinder body 72. The engagement between the shoulder 122 and the flange 124 prevents movement of the cylinder body 72 downward relative to the clamp ring 48.

The cylinder body 72 is held within the bore 120 by a separate mounting flange 126. The mounting flange 126, in turn, is held in place by the bolts 82. In the embodiment shown in FIG. 8, the separate mounting flange 126 allows the cylinder body to be formed without having to weld the mounting flange 126 to the cylinder body. The cylinder body 72 is held in place between the flange 126 and the lower shoulder 122 of the stepped bore formed within the clamp ring 48.

As can be understood by the above description, each of the clamping cylinder assemblies can be removed and serviced without requiring the complete removal of feed arrangement, bowl and the clamp ring, as was required in previously available cone crushers.

What is claimed is:

1. A gyratory crusher comprising:
a stationary adjustment ring having a series of threads;
a bowl having a series of external threads that engage the threads formed on the adjustment ring;
a head assembly positioned for movement within the bowl to create a crushing gap between the head assembly and the bowl;
a clamp ring positioned above the adjustment ring and having a series of threads that engage the external threads of the bowl, wherein the clamp ring includes a top face and a bottom face; and
a plurality of clamping cylinder assemblies each mounted to the top face of the clamp ring.

2. The gyratory crusher of claim 1 wherein each of the clamping cylinder assemblies includes a cylinder body that is received within a bore extending through the clamp ring from the top face to the bottom face.

3. The gyratory crusher of claim 2 wherein each of the clamping cylinder assemblies includes a mounting flange connected to the top face of the clamp ring by a plurality of connectors.

4. The gyratory crusher of claim 3 wherein each of the clamping cylinder assemblies includes a movable piston contained within the cylinder body, wherein a contact surface of the movable piston engages the adjustment ring.

5. The gyratory crusher of claim 4 further comprising a spacer connected to the adjustment ring, where in the contact surface of the piston engages both the adjustment ring and the spacer.

6. The gyratory crusher of claim I wherein each of the clamping cylinder assemblies is removable from the top face of the clamp ring while the clamp ring is engaged with he bowl.

7. The gyratory crusher of claim 1 wherein the clamp ring includes a plurality of bores that each extend through the clamp ring from the top face to the bottom face, wherein each of the plurality of clamping cylinder assemblies is received within one of the bores.

8. The gyratory crusher of claim 6 Wherein each of the clamping cylinder assemblies is attached to the top face of the clamp ring by a series of connectors.

9. A hydraulic clamping system for use with a gyratory crusher having a head assembly positioned for movement within a bowl that is movable relative to a stationary adjustment ring, the system comprising:
a clamp ring positioned above the adjustment ring and having a series of threads that engage a series of external threads of the bowl, the clamp ring including a top face and a bottom face; and
a plurality of clamping cylinder assemblies removably mounted to the top face of the clamp ring.

10. The hydraulic clamping system of claim 9 wherein each of the clamping cylinder assemblies includes a cylinder body that is received within a bore extending through the clamp ring from the top face to the bottom face.

11. The hydraulic clamping system of claim 10 wherein each of the clamping cylinder assemblies includes a mounting flange connected to the top face of the clamp ring by a plurality of connectors.

12. The hydraulic clamping system of claim 11 wherein each of the clamping cylinder assemblies includes a movable piston contained within the cylinder body, wherein a contact surface of the movable piston engages the adjustment ring.

13. The hydraulic clamping system of claim 12 further comprising a spacer connected to the adjustment ring, Where in the contact surface of the piston engages both the adjustment ring and the spacer.

14. The hydraulic clamping system of claim 9 wherein each of the clamping cylinder assemblies is removable from the top face of the clamp ring while the clamp ring is engaged with the bowl.

15. The hydraulic clamping system of claim 9 wherein each of the clamping cylinder assemblies is received within one of a plurality of bores that extend through the clamp ring from the top face to the bottom face, wherein each of the clamping cylinder assemblies includes a mounting flange securely attached to the top face of the clamp ring by a plurality of connectors such that the clamping cylinder assemblies can be removed by removing the connectors.
